(19) United States
(12) Patent Application Publication
(10) Pub. No.: US 2026/0274019 A1
(43) Pub. Date: Sep. 17, 2026

(54) Quick-Install Trailer Coupler Lock

(71) Applicant: NINGBO TENGYUE TECHNOLOGY CO., LTD., Ningbo (CN)

(72) Inventors: Teng Li, Ningbo (CN); Rong Cui, Ningbo (CN); Lijun Mao, Ningbo (CN)

(73) Assignee: NINGBO TENGYUE TECHNOLOGY CO., LTD., Ningbo (CN)

(21) Appl. No.: 19/176,242

(22) Filed: Apr. 11, 2025

(30) Foreign Application Priority Data
Mar. 12, 2025 (CN) 202520431361.5

(51) Int. Cl. B60D 1/60; B60D 1/06

(52) U.S. Cl. CPC B60D 1/60; B60D 1/06

(57) ABSTRACT

A quick-install trailer coupler lock, comprising a lock body including a ball head, a lock hole for installing a lock rod, a mounting shell, and a lock cylinder for locking the lock rod: the lock body and the lock rod lock a ball cover connector installed on the ball head, the mounting shell is provided with a movably installed stopper, a spring for providing elastic force to the stopper, and an inclined stress surface at the end; when the ball head on the lock body is installed into the ball cover connector, force is applied to the stress surface of the stopper to move the stopper; when the edge of the ball cover connector passes through the stopper, the force disappears, the spring drives the stopper to rebound and block the edge of the ball cover connector.

### RELATED APPLICATIONS

The present application claims the benefit of priority of Chinese Patent Application No. 202520431361.5, filed March 12, 2025 and entitled “QUICK - INSTALL TRAILER COUPLER LOCK,” the entire content of which is incorporated herein by reference.

### TECHNICAL FIELD

The present disclosure relates to a technical field of automobile trailer ball cover, in particular to a Quick-Install Trailer Coupler Lock.

### BACKGROUND

It is well known that a trailer ball is also called a trailer hook, a ball-type rear towing hook or a tow bar, a drawbar, etc. In a broad sense, the trailer ball is a complete set of trailer system which consists of three parts: a fixing bracket, a ball body and a power cord harness. The automobile trailer coupler lock is a locking device for fixing the trailer ball cover. When locking the trailer ball, a trailer lock cover is often used.

The existing coupler lock comprises a lock body, a toothed rod that can be installed on the lock body, a lock tongue and a lock cylinder respectively installed in the lock body, and a key matched with the lock cylinder; the lock body is provided with a ball structure matched with the ball cover.

Existing coupler locks have the following significant deficiencies in installation operations:

The installation process of the existing coupler lock requires cooperation of both hands to install the ball head into the ball cover connector. Since the connection port of the traditional ball cover connector is set downward, it is required to hold the lock body with one hand; otherwise, the lock body will fall naturally due to gravity, and the locking is completed by inserting the lock rod into the lock hole with the other hand, so that the lock rod and the lock body are connected with cooperation of both hands.

For personnel who need to operate with hand-held tools on a daily basis, they need to put down the tool in their hands to connect the lock rod and the lock body. Or the operation of this product is not friendly for the one-armed disabled, so the practicability of operating the existing coupler lock is poor.

### SUMMARY

### (I) Technical problems to be solved

In view of the shortcomings of the prior art, the present disclosure provides a quick-install trailer coupler lock, which solves the problem that the traditional coupler lock needs to be locked by workers with both hands.

### (II) Technical scheme

To achieve the above purpose, the present disclosure provides the following technical scheme: a quick-install trailer coupler lock, comprising a lock body, wherein the lock body is provided with a ball head, the lock body is provided with a lock hole for installing a lock rod, the lock rod is installed in the lock hole, and the lock body and the lock rod match to lock a ball cover connector installed on the ball head; a mounting shell is installed on the lock body, a stopper is movably installed in the mounting shell, a spring for providing elastic force to the stopper is arranged in the mounting shell, and an inclined stress surface is arranged at the end of the stopper; when the ball head on the lock body is installed into the ball cover connector, the edge of the ball cover connector acts on the stress surface of the stopper to make the stopper move; when the edge of the ball cover connector passes through the stopper, the edge of the ball cover connector no longer applies force to the stopper, the spring drives the stopper to rebound, and the rebounded stopper blocks the edge of the ball cover connector.

Further, the lock body is provided with a lock cylinder and the lock cylinder is used for locking the lock rod.

Further, the lock rod is provided with lock slots of different heights.

Further, a shifting block is fixedly arranged on the stopper, and a through slot for the shifting block is formed on the mounting shell.

Further, the mounting shell is movable on the lock body to switch the blocking state of the stopper against the edge of the ball cover connector.

Further, a connecting frame for driving the mounting shell is installed on the mounting shell, a connecting part is arranged on the lock body, the connecting frame penetrates through the connecting part, and the connecting frame can move along the guiding direction of the connecting part.

Further, a protruding driving block is arranged on the connecting frame.

Further, a connecting block for fixing an end of the spring is arranged in the mounting shell, a connecting shaft is arranged in the mounting shell, and a sliding slot matched with the connecting shaft is formed inside the stopper.

Further, the lock rod has a structure with one longer side and one shorter side, the lock slots are arranged on the shorter side of the lock rod, and a limiting block is arranged at the bottom of the longer side of the lock rod.

Further, a diameter of the limiting block is larger than that of the lock hole.

### (III) Beneficial Effects

Compared with the prior art, the present disclosure provides a quick-install trailer coupler lock, which has the following beneficial effects:

The quick-install trailer coupler lock is provided with a mounting shell, a stopper and a spring. An inclined stress surface is arranged at the end of the stopper. When installing the lock body, the ball head is installed in the ball cover connector from bottom to top. The acting force of the edge of the ball cover connector acts on the inclined stress surface of the stopper to make it move. After the edge of the ball cover connector passes through the stopper, the spring drives the stopper to rebound and block the edge, and the stopper blocks above the edge of the ball cover connector to prevent the lock body from falling. At this time, the lock rod is inserted into the lock hole on the lock body, and the installation of the lock rod and the lock body can be completed with one hand, which improves the convenience and practicability of operation.

For those who often operate with hand-held tools, the one-hand operation avoids the inconvenience of two-hand operation, so that they can easily install the coupler lock without putting down the tool during work. For special groups such as the one-arm disabled, the design solves the problem that they could not operate in the past, enhances the applicability of the product to different groups of people, and reflects the friendliness of the product use.

### BRIEF DESCRIPTION OF THE DRAWINGS

FIG. 1 is a three-dimensional structural schematic diagram of this present disclosure;

FIG. 2 is a front-view structural schematic diagram of this present disclosure;

FIG. 3 is a three-dimensional structural schematic diagram of the lock body matching with the ball cover connector in this present disclosure, wherein the first embodiment of the movable stopper is adopted;

FIG. 4 is a three-dimensional structural schematic diagram of the lock body matching with the ball cover connector in this present disclosure, wherein the second embodiment of the movable stopper is adopted;

FIG. 5 is a three-dimensional structural schematic diagram of the lock body matching with the ball cover connector in this present disclosure, wherein the second embodiment of the movable stopper is adopted to move the stopper;

FIG. 6 is a three-dimensional structural schematic diagram of the stopper in this present disclosure, wherein the stopper in the first embodiment is adopted;

FIG. 7 is a cross-sectional structural schematic diagram of the stopper in the present disclosure, wherein the stopper in the first embodiment is adopted;

FIG. 8 is a three-dimensional structural schematic diagram of the stopper in the present disclosure, wherein the stopper in the second embodiment is adopted;

FIG. 9 is a cross-sectional structural schematic diagram of the stopper in the present disclosure, wherein the stopper in the second embodiment is adopted;

FIG. 10 is a partially enlarged structural diagram at A shown in FIG. 1 of the present disclosure;

FIG. 11 is a partially enlarged structural diagram at B shown in FIG. 5 of this present disclosure;

FIG. 12 is an inverted first three-dimensional structural schematic diagram of this present disclosure, wherein a handle is installed on the lock body;

FIG. 13 is an inverted second three-dimensional structural schematic diagram of this present disclosure, wherein a handle is installed on the lock body.

### REFERENCE NUMERALS

1. Lock body; 2. Lock rod; 3. Lock hole; 4. Lock slots; 5. Lock cylinder; 6. Ball head; 7. Ball cover connector; 8. Edge; 9. Limiting block; 10. Mounting shell; 11. Stopper; 12. Stress surface; 13. Spring; 14. Connecting block; 15. Connecting shaft; 16. Sliding slot; 17. Through slot; 18. Shifting block; 19. Connecting frame; 20. Connecting part; 21. Driving block; 22. Mounting block; 23. Handle; 24. Connecting shaft; 25. Anti-skid mat; 26. Nameplate.

### DETAILED DESCRIPTION

The following description provides a clear and complete description for the technical solutions in the embodiments of the present disclosure along with the drawings in the embodiments. Obviously, the embodiments are only some of rather than all of the embodiments of the present disclosure. Any other embodiments acquired by persons of ordinary skills in the art without creative efforts but based on the embodiments of the present disclosure are covered by the range of protection by the present disclosure.

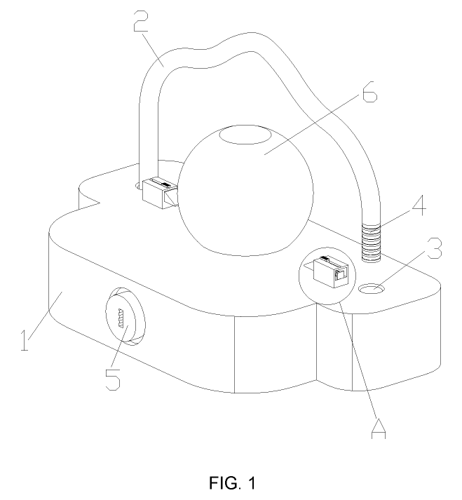

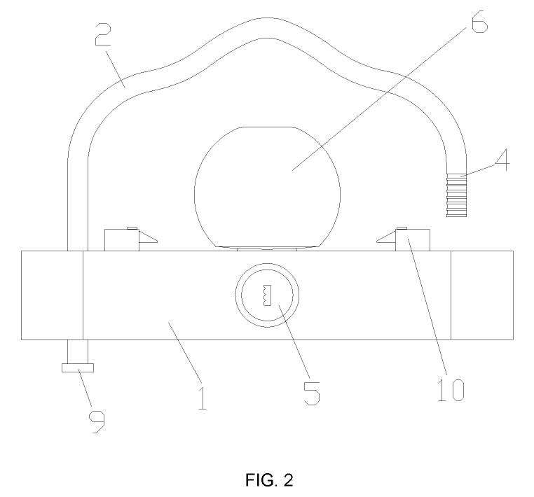

Referring to FIGS. 1 and 2, a quick-install trailer coupler lock of the present invention comprises a lock body 1, wherein the lock body 1 is provided with a ball head 6. However, the ball head 6 of any shape or structure can be used as the ball head 6 of the present disclosure, such as cylinder-shaped and hook-shaped ball heads 6.

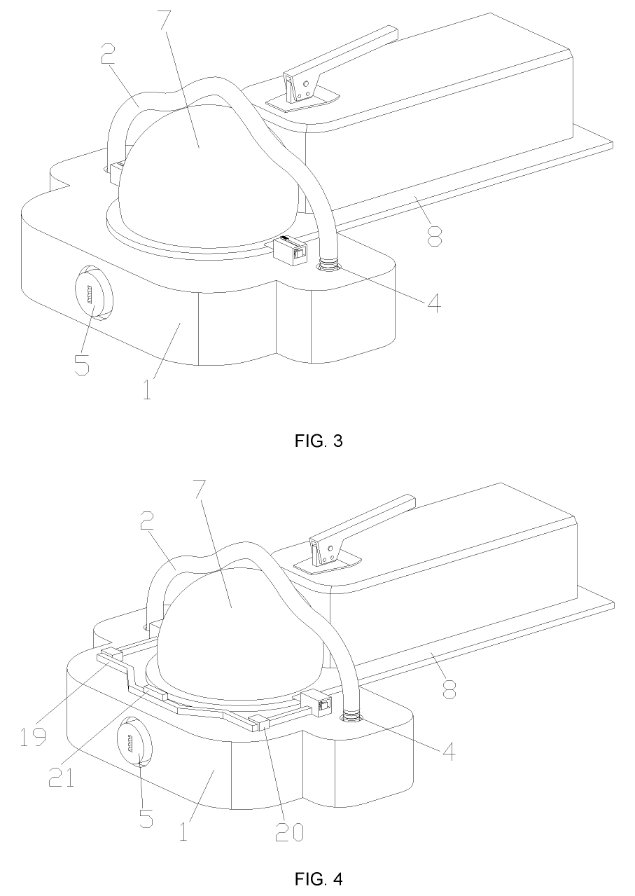

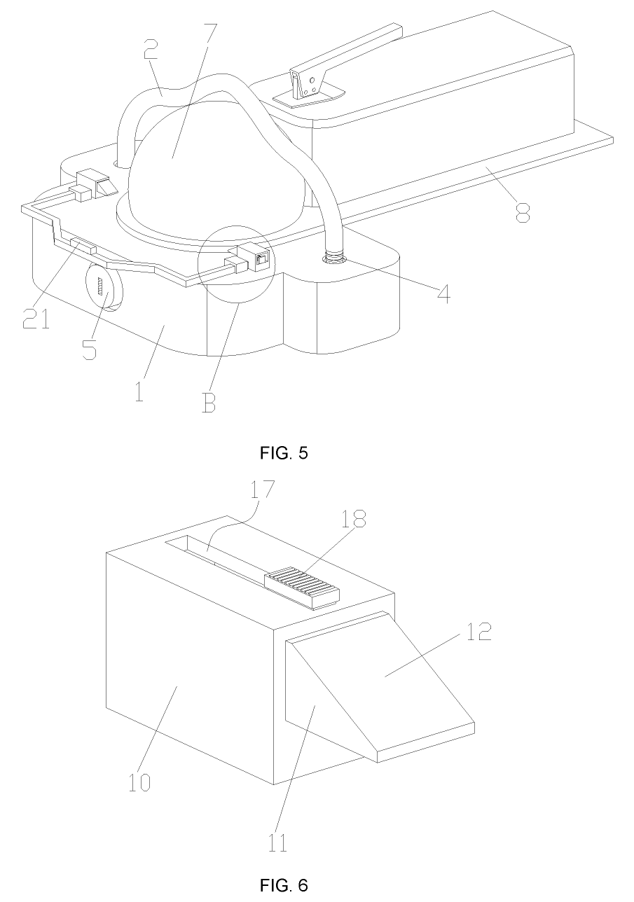

As shown in FIGS. 3-5, the lock body 1 is provided with a lock hole 3 for installing the lock rod 2, and the lock rod 2 is installed in the lock hole 3. The lock body 1 and the lock rod 2 match to lock the ball cover connector 7 installed on the ball head 6. The lock body 1 is provided with a lock cylinder 5 and the lock cylinder 5 is used for locking the lock rod 2. The lock rod 2 is provided with lock slots 4, a key matched with the lock cylinder 5, and a lock tongue arranged on the lock cylinder 5. When it is required to lock the lock rod 2, insert the matched key into the lock cylinder 5, and rotate the key to drive the lock tongue on the lock cylinder 5 to move, so that the lock tongue enters the locking slot 4 on the lock rod 2, thus completing the locking of the lock rod 2 and keeping the lock body 1 in a locked state. When it is required to unlock, insert the key into the lock cylinder 5 and turn the key reversely, so that the lock tongue withdraws from the lock slot 4. At this time, the lock body 1 cannot lock the lock rod 2, and the lock rod 2 is in an openable state, so the lock rod 2 can be taken out of the lock hole 3.

Several lock slots 4 are arranged on the lock rod 2, and the heights of the lock slots 4 on the lock rod 2 are different. The lock tongue is locked into the lock slots 4 with different heights, and the reserved height of the upper part of the lock rod 2 can be adjusted, so that the reserved height of the upper part of the lock rod 2 is different, adapting to the ball cover connector 7 with different heights.

A mounting shell 10 is installed on the lock body 1, and at least one stopper 11 is movably installed in the mounting shell 10. A spring 13 for providing elastic force to the stopper 11 is arranged in the mounting shell 10, a connecting block 14 for fixing an end of the spring 13 is arranged in the mounting shell 10, a connecting shaft 15 is arranged in the mounting shell 10, and a sliding slot 16 matched with the connecting shaft 15 is formed inside the stopper 11. The matching of the connecting shaft 15 and the sliding slot 16 improves the stability of movement of the stopper 11. The end of the stopper 11 is provided with an inclined stress surface 12 and the inclined stress surface 12 faces upwards. When the ball head 6 on the lock body 1 is installed into the ball cover connector 7 from bottom to top, the edge 8 of the ball cover connector 7 will generate a force on the stress surface 12 of the stopper 11, and the edge 8 of the ball cover connector 7 will act on the stress surface 12 of the stopper 11 to make the stopper 11 move. When the edge 8 of the ball cover connector 7 passes through the stopper 11, the edge 8 is located below the stopper 11, and the edge 8 of the ball cover connector 7 no longer applies force to the stopper 11. The spring 13 drives the stopper 11 to rebound, and the bottom of the rebounded stopper 11 blocks above the edge 8 of the ball cover connector 7, preventing the lock body 1 from falling down. At this time, the lock rod 2 is inserted into the lock hole 3 on the lock body 1, and the installation of the lock rod 2 and the lock body 1 can be completed with one hand.

When removing the lock body 1, it is required to move the stopper 11, otherwise the ball head 6 cannot be disengaged from the ball cover connector 7. There are two embodiments of moving the stopper 11:

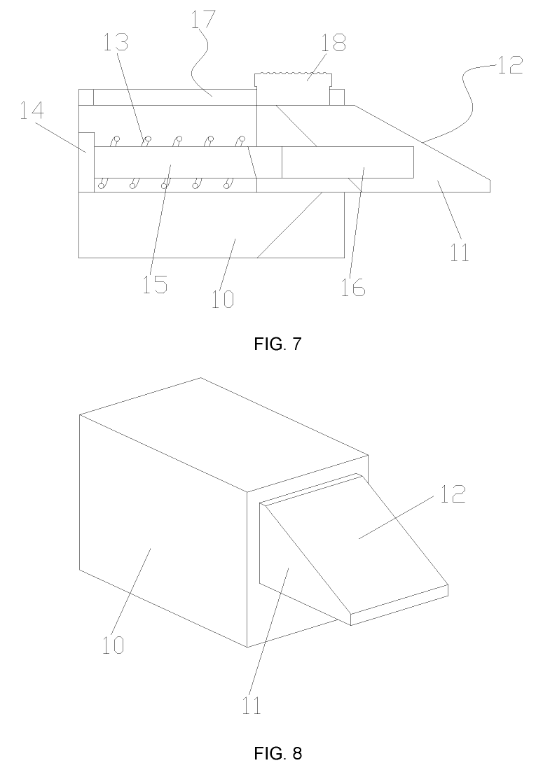

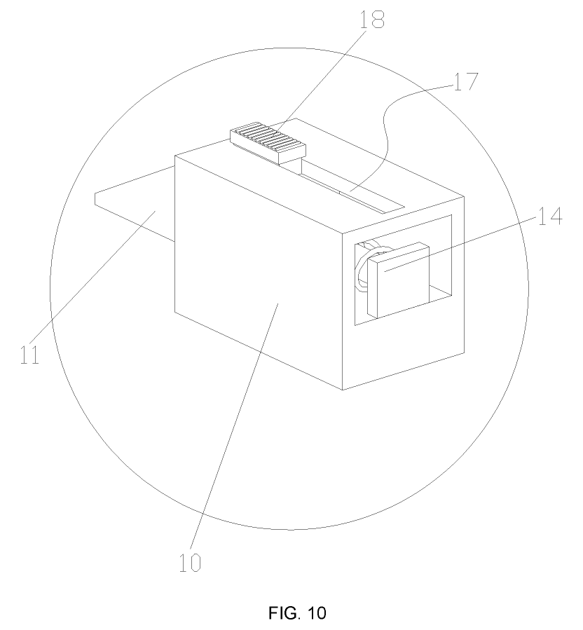

In a first embodiment of moving the stopper 11, as shown in FIGS. 3, 6, 7 and 10, the mounting shell 10 is fixedly connected with the lock body 1, a shifting block 18 is fixedly arranged on the stopper 11, and a through slot 17 for the shifting block 18 is formed on the mounting shell 10. After the lock rod 2 is opened, the shifting block 18 can be moved along the length direction of the through slot 17 to move the stopper 11 away from the edge 8 of the ball cover connector 7. At this time, the ball head 6 on the lock body 1 can be removed from the ball cover connector 7. Outer wall of the shifting block 18 is provided with a protective lines.

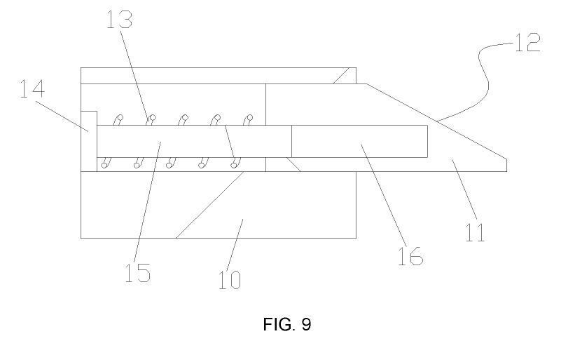

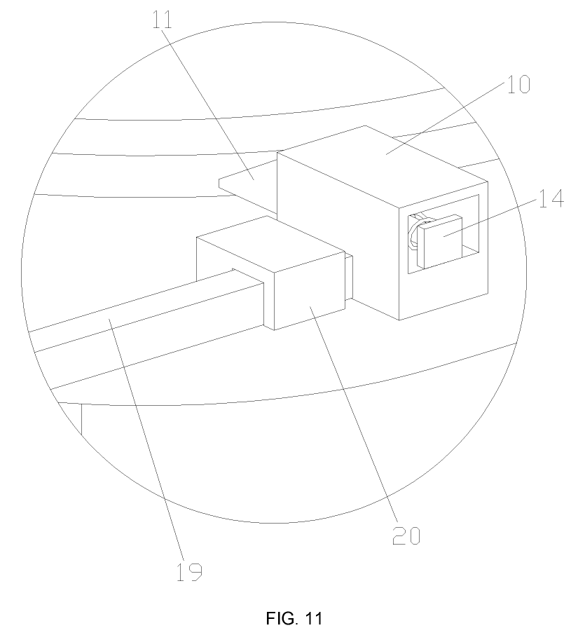

In a second embodiment of moving the stopper 11, as shown in FIGS. 4, 5, 8, 9 and 11, the mounting shell 10 is displaceable on the lock body 1 to switch the blocking state of the stopper 11 against the edge 8 of the ball cover connector 7, that is, when the stopper 11 approaches and is located above the edge 8 of the ball cover connector 7, the stopper 11 can block the edge 8 of the ball cover connector 7; when the stopper 11 is away from and not above the edge 8 of the ball cover connector 7, the stopper 11 cannot block the edge 8 of the ball cover connector 7 and the position (blocking state) of the stopper 11 can be switched by moving the mounting shell 10. A connecting frame 19 for driving the mounting shell 10 is installed on the mounting shell 10. A connecting part 20 is arranged on the lock body 1, and the connecting frame 19 penetrates through the connecting part 20. The connecting frame 19 can move along the guiding direction in the connecting part 20, and a protruding driving block 21 is arranged on the connecting frame 19 to facilitate the driving and operation of the connecting frame 19. After the lock rod 2 is opened, the connecting frame 19 is driven to move the stopper 11 in the mounting shell 10 away from the edge 8 of the ball cover connector 7, so that the stopper is not located above the edge 8 of the ball cover connector 7. At this time, the ball head 6 on the lock body 1 can be removed from the ball cover connector 7.

Further, in order to facilitate the installation of the lock rod 2, the lock rod 2 has a structure with one longer side and one shorter side. Lock slots 4 are arranged on the shorter side of the lock rod 2. A limiting block 9 is arranged at the bottom of the longer side of the lock rod 2, and the diameter of the limiting block 9 is larger than that of the lock hole 3. When the shorter side of the lock rod 2 is disengaged from the lock hole 3, the longer side of the lock rod 2 can rotate in the axial direction of the lock hole 3. The limiting block 9 prevents the lock rod 2 from separating from lock body 1, and plays a role of anti-losing, and also facilitates the lock rod 2 to be inserted into the lock hole 3.

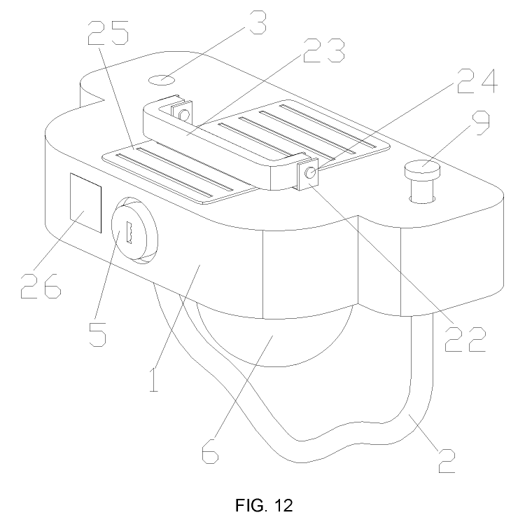

As shown in FIG. 12, a handle 23 is arranged on the bottom end face of the lock body 1, and a gap is reserved between the inside of the handle 23 and the bottom wall of the lock body 1 for the hand. During installation, the lock body 1 can be held stably by putting a hand through the internal gap of the handle 23 and supporting the bottom end face of the lock body 1 with palm. The handle 23 can effectively enhance the stability of holding the lock body 1, prevent the lock body 1 from falling due to hand slipping or careless operation, further reduce the accident risk caused by falling of the lock body 1 during installation, and ensure smooth installation of the lock body 1.

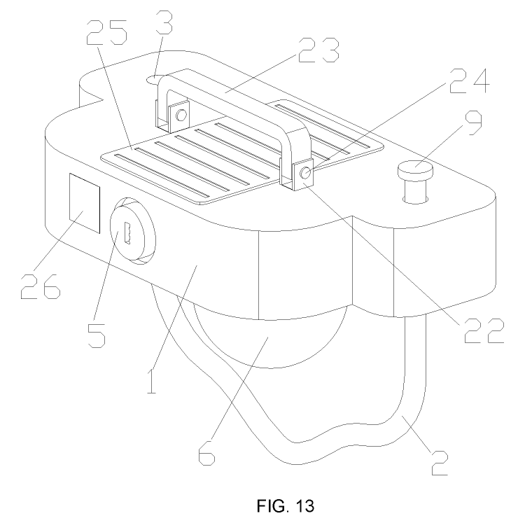

As shown in FIGS. 12-13, for further details, a mounting block 22 is fixedly arranged on the bottom end face of the lock body 1. The mounting block 22 and the handle 23 are connected by a connecting shaft 24, so that the handle 23 can be flexibly folded. A certain damping force exists between the handle 23 and the mounting block 22, so that the handle 23 can be maintained at a certain inclination angle. When it is required to use the handle 23, the handle 23 can be folded down along the connecting shaft 24 until the whole handle 23 is perpendicular to the bottom end face of the lock body 1. At this time, the handle 23 is in a use state, which facilitates the hand to hold (support) the lock body 1 through the handle 23. When the handle 23 is not used, it can be folded forward or backward along the connecting shaft 24 so that the handle 23 is parallel to the bottom end face of the lock body 1. This design can effectively reduce the space occupied by the lock body 1 during storage or placement and facilitate proper keeping or carrying of the lock body 1.

As shown in FIGS. 12-13, an anti-skid mat 25 is additionally provided on the bottom end face of the lock body 1. The anti-skid mat 25 can be in close contact with the hand when the hand passes through the handle 23 to hold (support) the lock body 1, which effectively increases friction, provides an anti-skid effect, and avoid accidental falling of the lock body 1 due to hand slipping, thus ensuring safety and stability during operation. In addition, considering that the lock body 1 is generally made of a metal material, direct contact may make hands feel cold and uncomfortable in cold winter. The anti-skid mat 25 just acts as a barrier layer to separate the lock body 1 from your hand, so that you can hold the lock body 1 comfortably even in cold weather and avoid the cold feeling on your hand.

As shown in FIGS. 12-13, in order to quickly find the matching lock body 1, a nameplate 26 is arranged on the outer wall of the lock body 1, and various key model information are clearly marked on the nameplate 26, such as the specific length of the lock rod 2, the upper limit and lower limit of the lock rod 2, the diameter or model of the ball head 6 and other important information. It is convenient for the user to find a suitable lock body 1.

To sum up, when the quick-install trailer coupler lock is in use, the ball head 6 is aligned with the ball cover connector 7 and pushed upward. During pushing, the edge 8 of the ball cover connector 7 contacts the stress surface 12 of the stopper 11 and generates a force to move the stopper 11.

After the edge 8 of the ball cover connector 7 passes through the stopper 11, the edge 8 is located below the stopper 11. At this time, no force is applied to the stopper 11, and the spring 13 drives the stopper 11 to rebound. The bottom of the rebounded stopper 11 will block above the edge 8 of the ball cover connector 7, preventing the lock body 1 from falling. When the stopper 11 blocks the edge 8 of the ball cover connector 7 and the lock body 1 is stable, insert the lock rod 2 into the lock hole 3 on the lock body 1, insert a key into the lock cylinder 5 and turn the key, so that the lock tongue enters the corresponding lock slot 4 to complete the installation of the lock rod 2 and the lock body 1.

When removing the lock body 1, insert a key into the lock cylinder 5 and turn the key reversely to withdraw the lock tongue from the lock slot 4, thus unlocking the lock rod 2. After the lock tongue exits from the lock slot 4, pull out the lock rod 2 from the lock hole 3 of the lock body 1.

By moving the shifting block 18 or the connecting frame 19, the stopper 11 is operated to produce a displacement. The stopper 11 originally blocking above the edge 8 of the ball cover connector 7 is moved and no longer forms a block against the edge 8.

At this time, the lock body 1 can be removed from the ball cover connector 7, completing the removal process of the lock body 1.

Although embodiments of the present disclosure have been shown and described, it will be understood by those of ordinary skill in the art that many changes, modifications, substitutions and variations can be made to these embodiments without departing from the principle and spirit of the present disclosure, and the scope of the present disclosure is defined by the appended claims and their equivalents.

What is claimed is:

1. A quick-install trailer coupler lock, comprising a lock body (1), wherein the lock body (1) is provided with a ball head (6), the lock body (1) is provided with a lock hole (3) for installing a lock rod (2), the lock rod (2) is installed in the lock hole (3), and the lock body (1) and the lock rod (2) match to lock a ball cover connector (7) installed on the ball head (6); a mounting shell (10) is installed on the lock body (1), a stopper (11) is movably installed in the mounting shell (10), a spring (13) for providing elastic force to the stopper (11) is arranged in the mounting shell (10), and an inclined stress surface (12) is arranged at the end of the stopper (11); when the ball head (6) on the lock body (1) is installed into the ball cover connector (7), the edge (8) of the ball cover connector (7) acts on the stress surface (12) of the stopper (11) to make the stopper (11) move; when the edge (8) of the ball cover connector (7) passes through the stopper (11), the edge (8) of the ball cover connector (7) no longer applies force to the stopper (11), the spring (13) drives the stopper (11) to rebound, and the rebounded stopper (11) blocks the edge (8) of the ball cover connector (7).

2. The quick-install trailer coupler lock according to claim 1, wherein the lock body (1) is provided with a lock cylinder (5) and the lock cylinder (5) is used for locking the lock rod (2).

3. The quick-install trailer coupler lock according to claim 2, wherein the lock rod (2) is provided with lock slots (4) of different heights.

4. The quick-install trailer coupler lock according to claim 1, wherein a shifting block (18) is fixedly arranged on the stopper (11), and a through slot (17) for the shifting block (18) is formed on the mounting shell (10).

5. The quick-install trailer coupler lock according to claim 1, wherein the mounting shell (10) is movable on the lock body (1) to switch the blocking state of the stopper (11) against the edge (8) of the ball cover connector (7).

6. The quick-install trailer coupler lock according to claim 5, wherein a connecting frame (19) for driving the mounting shell (10) is installed on the mounting shell (10), a connecting part (20) is arranged on the lock body (1), the connecting frame (19) penetrates through the connecting part (20), and the connecting frame (19) can move along the guiding direction of the connecting part (20).

7. The quick-install trailer coupler lock according to claim 6, wherein a protruding driving block (21) is arranged on the connecting frame (19).

8. The quick-install trailer coupler lock according to claim 1, wherein a connecting block (14) for fixing an end of the spring (13) is arranged in the mounting shell (10), a connecting shaft (15) is arranged in the mounting shell (10), and a sliding slot (16) matched with the connecting shaft (15) is formed inside the stopper (11).

9. The quick-install trailer coupler lock according to claim 3, wherein the lock rod (2) has a structure with one longer side and one shorter side, the lock slots (4) are arranged on the shorter side of the lock rod (2), and a limiting block (9) is arranged at the bottom of the longer side of the lock rod (2).

10. The quick-install trailer coupler lock according to claim 9, wherein a diameter of the limiting block (9) is larger than that of the lock hole (3).

11. A quick-install trailer coupler lock assembly comprising at least the quick-install trailer coupler lock of claim 1.

12. A coupler lock assembly comprising at least the quick-install trailer coupler lock of claim 1.
